(19) United States
(12) Patent Application Publication
(10) Pub. No.: US 2014/0009956 A1
(43) Pub. Date: Jan. 9, 2014

(54) OMNI-DIRECTIONAL LIGHTING APPARATUS

(71) Applicants: Luca Bordin, Munich (DE); Zhenjian Liang, Shenzhen (CN); Jing Lin, Shenzhen (CN); Junhua Zeng, Shenzhen (CN)

(72) Inventors: Luca Bordin, Munich (DE); Zhenjian Liang, Shenzhen (CN); Jing Lin, Shenzhen (CN); Junhua Zeng, Shenzhen (CN)

(21) Appl. No.: 14/006,608

(22) PCT Filed: Feb. 24, 2012
(86) PCT No.: PCT/EP2012/053171

§ 371 Date: Sep. 20, 2013

(30) Foreign Application Priority Data
Mar. 21, 2011 (CN) 201110068093.8

(51) Int. Cl. F21V 8/00

(52) U.S. Cl. CPC G02B 6/0096
USPC 362/551

(57) ABSTRACT

An omnidirectional lighting apparatus including a lamp housing and a light source provided in the lamp housing. The omni-directional lighting apparatus further includes at least one light pipe provided in the lamp housing. A light from the light source strikes in the light pipe (2) and escapes through the lamp housing in a direction of 360° after at least one time of total internal reflection by the light pipe.

### RELATED APPLICATIONS

This is a U.S. national stage of International application No. PCT/EP2012/053171 filed on Feb. 24, 2012.

This application claims the priority of Chinese application no. 2011 100 68 093.8 filed Mar. 21, 2011, the entire content of which is hereby incorporated by reference.

### FIELD OF THE INVENTION

The present invention relates to omnidirectional lighting apparatus.

### BACKGROUND OF THE INVENTION

In the current light apparatus, the LED light source has been widely used. However, due to the special configurations of the LED light source and the mirror used in matching thereto, a single LED light source can hardly realize 360° omnidirectional illuminance. Of course, in order to realize the omnidirectional illuminance in the light apparatus using the LED light source, many sets of LED light sources and the lenses can be combined to implement omni-directional illuminance. But in such lighting apparatus, as a plurality of LED light sources are required, a high driving voltage is needed, and the cost, life time and safe factor are hard to be controlled.

In some other solutions, for the sake of omnidirectional illuminance, the specially designed lenses with a complicated structure is used, but the light source in such lighting apparatus cannot be changed freely, so the luminance and structure are limited, and even the real 360° illuminance cannot be reached. Besides, the lighting apparatus of such type can hardly get a uniform color distribution.

### SUMMARY OF THE INVENTION

One object of the present invention is to provide omnidirectional lighting apparatus. Such lighting apparatus realizes real omnidirectional illuminance and is capable of obtaining good color mixing uniformity and favorable color distribution uniformity.

This and other objects are attained in accordance with one aspect of the present invention directed to an omnidirectional lighting apparatus comprising a lamp housing, a light source provided in the lamp housing, wherein the omnidirectional lighting apparatus further comprises at least one light pipe provided in the lamp housing, a light from the light source strikes in the light pipe and escapes through the lamp housing in a direction of 360° after at least one time of total internal reflection by the light pipe. With the above structure, the omnidirectional lighting apparatus according to the present invention implements real omnidirectional illuminance.

In accordance with an embodiment of the present invention, the light source is provided under the light pipe so that all light from the light source can directly go into the light pipe, and the light is totally internally reflected in the light pipe based on the physical properties of the light pipe. The Fresnel Lost is zero, allowing the whole lighting apparatus to have a high optical efficiency.

Preferably, each light pipe comprises a light incident surface, a light guiding channel and two light emergent surfaces, wherein as viewed from a longitudinal direction of the light pipe, the light incident surface is provided on a lower surface on a middle position of the light pipe, and the light emergent surfaces are provided on two end surfaces of the light pipe, respectively. As the light source is provided under the light pipe, the light from the light source can strike from the light incident surface provided on the lower surface on the middle position of the light pipe, and escape from two light emergent surfaces, respectively, after totally internally reflected in the light guiding channel. The light escaping from the two light emergent surfaces cover a range of 180°, respectively, so as to jointly implement illuminance of 360°. Besides, as the omni-directional lighting apparatus according to the present invention uses the light pipe to implement omnidirectional illuminance, the cost is reduced since the specially designed lens structure is not used for the omnidirectional illuminance.

It is provided according to an embodiment of the present invention that an optical axis of the light source passes through the light pipe to form two light pipe portions that are symmetrical in relation to the optical axis. Thus, the incident light passes through the same route in the light pipe portions at both sides of the optical axis, so as to obtain a consistent optical output on the two light emergent surfaces, thereby allowing good illuminance and optical intensity distribution of the lighting apparatus. Most light sources have the problem of non-uniform color distribution, then when the light escapes after several times of reflection in the light pipe, non-uniform light will be sufficiently mixed to yield a consistent color mixing distribution.

Besides, advantageously, an upper surface of each light pipe is formed with a V-shaped groove, the optical axis runs through a top of the V-shaped groove, respective inner side surfaces of two slopes of the V-shaped groove are formed with total internal reflection surfaces, at least a part of light from the light source is reflected into the light pipe portions corresponding to respective light emergent surfaces through the respective inner side surfaces. With such structure and design, at least a part of light from the light source can be well reflected to the light pipe to prevent the light from escaping from the light pipe towards the light source, therefore further improving the optical efficiency of the lighting apparatus according to the present invention.

It is provided according to an embodiment of the present invention that each light pipe, starting from the V-shaped groove, gradually gets thinner to a direction of the light emergent surfaces at both sides of the V-shaped groove. According to the solution in the present invention, the lighting apparatus in the present invention can use not only a light source of a high power but also a light source of a low power. If the light source is changed, the output angle of all light can be regulated as long as the total internal reflection surface and a relative angle between the upper surface and lower surface of and the light pipe are adjusted, so as to implement ideal omnidirectional illuminance as expected.

Preferably, the lamp housing is provided with two light pipes that are arranged to be orthogonal with each other and coincide at the optical axis. This further improves the capability of the lighting apparatus according to the present invention of providing 360° omnidirectional illuminance, thus enabling more uniform illuminance in various directions. A plurality of light pipes, of course, can be used in the solution of the present invention. These light pipes are staggered with a certain angle therebetween and coincide at the optical axis.

Further preferably, a cross section of the light pipe is designed to be circular-shaped or polygon-shaped.

It is provided according to an embodiment of the present invention that the light pipe is designed to be in a solid structure. The light pipe of such type has a simpler structure and low cost.

Preferably, the light pipe is designed to be in a hollow structure, wherein an inner wall of the light pipe is de-signed to be in a mirror structure an average reflection factor more than 98%, so as to improve the total internal reflection performance of the light pipe. Moreover, the light pipe with a hollow structure also prominently reduces the weight of the entire lighting apparatus.

### BRIEF DESCRIPTION OF THE DRAWINGS

In the drawings, the same element is represented by the same reference sign.

FIG. 1 is a schematic view of a light pipe of omnidirectional lighting apparatus according to an embodiment of the present invention;

FIG. 2 is a perspective view of omnidirectional lighting apparatus according to an embodiment of the present invention, wherein one light pipe is provided;

FIG. 3 is a perspective view of omnidirectional lighting apparatus according to an embodiment of the present invention, wherein two light pipes are provided; and

FIG. 4 is an analogue optical intensity distribution diagram of omnidirectional lighting apparatus according to an embodiment of the present invention.

### DETAILED DESCRIPTION OF THE DRAWINGS

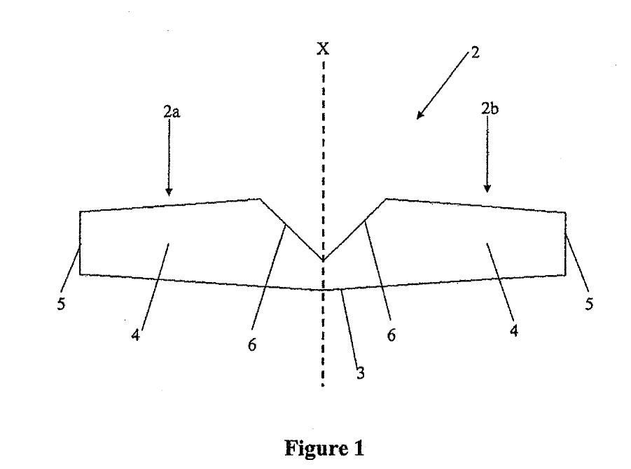

FIG. 1 is a schematic view of a light pipe 2 of omnidirectional lighting apparatus according to the present invention. It can be seen from the figure that the light pipe comprises a light incident surface 3, a light guiding channel 4 and two light emergent surfaces 5, wherein as viewed from a longitudinal direction of the light pipe 2, the light incident surface 3 is provided on a lower surface on a middle position of the light pipe 2, and the light emergent surfaces 5 are provided on two end surfaces of the light pipe 2, respectively. A light source that is not shown is provided under the light pipe 2, an optical axis X of the light source runs through the light pipe 2 crossing a longitudinal direction of the light pipe 2, and light pipe portions 2a and 2b at both sides of the optical axis X are symmetrical in relation to the optical axis X.

Besides, an upper surface of each light pipe 2 is formed with a V-shaped groove, and the optical axis X runs through a top of the V-shaped groove. Respective inner side surfaces of two slopes of the V-shaped groove are formed with total internal reflection surfaces 6, at least a part of light from the light source is reflected into the light pipe portions 2a and 2b corresponding to respective light emergent surfaces 5 through respective inner side surfaces. It can be seen from FIG. 1 that the light pipe 2, starting from the V-shaped groove, gradually gets thinner to a direction of the light emergent surfaces 5 at both sides of the V-shaped groove so as to assure that all light can escape from the light emergent surfaces 5.

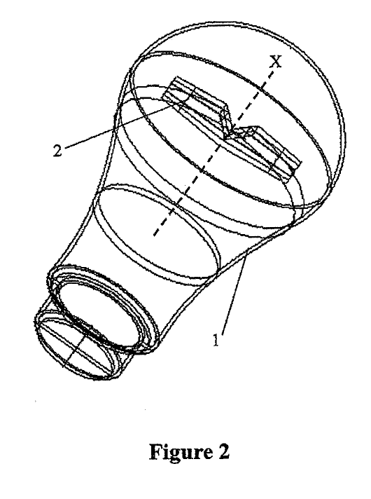

FIG. 2 shows a perspective view of omnidirectional lighting apparatus according to the present invention. It can be seen from the figure that the omnidirectional lighting apparatus comprises a lamp housing 1 and a light pipe 2 provided in the lamp housing 1. In the present embodiment, only one light pipe 2 is provided. Particularly, a light source is provided under the light pipe 2, but, for the sake of simplicity, is not shown in the figure.

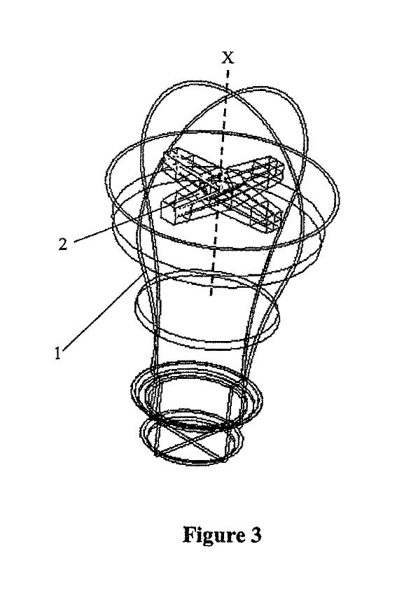

FIG. 3 also shows a perspective view of omnidirectional lighting apparatus according to the present invention. It is different from the omnidirectional lighting apparatus shown in FIG. 2 merely in that the omnidirectional lighting apparatus shown in FIG. 3 has two light pipes 2 that are arranged to be orthogonal with each other and coincide at the optical axis X.

A cross section of the light pipe 2 shown in the figure is quadrilateral-shaped, and also can be designed to be circular-shaped or polygon-shaped. In addition, the light pipe according to the present invention is designed to be in a solid structure. Preferably, the light pipe is designed to be in a hollow structure, wherein an inner wall of the light pipe is designed to be in a mirror structure with a high reflection factor.

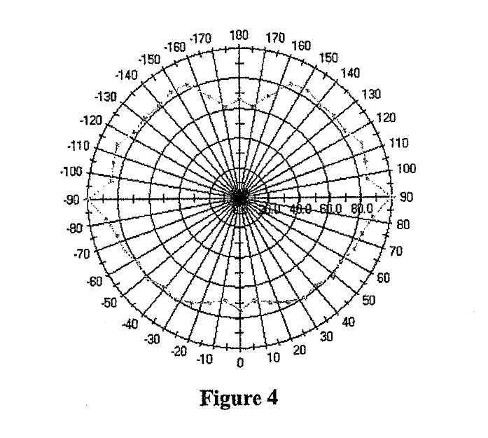

FIG. 4 is an analogue optical intensity distribution diagram of omnidirectional lighting apparatus according to the present invention. The direction is viewed downwardly from an upper direction of the diagram shown in the figure, i.e. viewed from a directly upper direction of the light source. The software analogue data of the optical intensity distribution diagram is based on the omnidirectional lighting apparatus provided with two light pipes arranged to be orthogonal with each other. It can be seen from the figure that the optical efficiency in directions of 90° and −90° is slightly high, while the optical efficiency in directions of 0° and −180° is slightly low, and the optical efficiency in other directions is basically maintained at a level of about 85%. The optical distribution of the light emitted from the omnidirectional lighting apparatus according to the present invention is substantively uniform in various directions, and a good omnidirectional illuminance performance has been achieved.

The above is merely preferred embodiments of the present invention but not to limit the present invention. For the person skilled in the art, the present invention may have various alterations and changes. Any alterations, equivalent substitutions, improvements, within the spirit and principle of the present invention, should be covered in the protection scope of the present invention.

1. An omnidirectional lighting apparatus, comprising a lamp housing, a light source provided in the lamp housing, wherein the omni-directional lighting apparatus further comprises at least one light pipe provided in the lamp housing, a light from the light source strikes in the light pipe and escapes through the lamp housing in a direction of 360° after at least one time of total internal re-flection by the light pipe.

2. The omnidirectional lighting apparatus according to claim 1, wherein the light source is provided under the light pipe.

3. The omnidirectional lighting apparatus according to claim 2, wherein the light pipe comprises a light incident surface, a light guiding channel and two light emergent surfaces, and wherein as viewed from a longitudinal direction of the light pipe, the light incident surface is provided on a lower surface on a middle position of the light pipe, and the light emergent surfaces are provided on two end surfaces of the light pipe, respectively.

4. The omnidirectional lighting apparatus according to claim 3, wherein an optical axis (X) of the light source passes through the light pipe to form two light pipe portions that are symmetrical in relation to the optical axis (X).

5. The omnidirectional lighting apparatus according to claim 4, wherein an upper surface of each of the light pipes is formed with a V-shaped groove, the optical axis (X) runs through a top of the V-shaped groove, respective inner side surfaces of two slopes of the V-shaped groove are formed with total internal reflection surface, at least a part of light from the light source is reflected into light pipe portions corresponding to respective light emergent surfaces through the respective inner side surfaces.

6. The omnidirectional lighting apparatus according to claim 4, wherein the light pipe, starting from the V-shaped groove, gradually gets thinner to a direction of the light emergent surfaces at both sides of the V-shaped groove.

7. The omnidirectional lighting apparatus according to claim 1, wherein the lamp housing is provided with two light pipes therein, the two light pipes are arranged to be orthogonal with each other and coincide at the optical axis (X).

8. The omni-directional lighting apparatus according to claim 1, wherein a cross section of the light pipe is configured to be circular-shaped or polygon-shaped.

9. The omnidirectional lighting apparatus according to claim 1, wherein the light pipe is configured to be in a solid structure.

10. The omnidirectional lighting apparatus according to claim 1, wherein the light pipe is configured to be in a hollow structure, and wherein an inner wall of the light pipe is designed to be in a mirror structure with an average reflection factor more than 98%.
